(19) United States
(12) Patent Application Publication
(10) Pub. No.: US 2015/0370351 A1
(43) Pub. Date: Dec. 24, 2015

(54) Pen Input Device Used With Mobile Device

(71) Applicant: ACE CAD ENTERPRISE CO., LTD., New Taipei City (TW)

(72) Inventors: Yuan-Heng Wu, New Taipei City (TW); Chien-Feng Wang, New Taipei City (TW); Kuang-Che Teng, New Taipei City (TW); Wei-Chao Wu, New Taipei City (TW)

(21) Appl. No.: 14/574,402

(22) Filed: Dec. 18, 2014

(30) Foreign Application Priority Data
Jun. 19, 2014 (TW) 103210817

(51) Int. Cl. G06F 3/0354; G06F 3/046

(52) U.S. Cl. CPC G06F 3/03545; G06F 3/046

(57) ABSTRACT

A pen input device used with mobile device includes a digital pen, which includes an ink cartridge and is provided therein with an electromagnetic wave emitting circuit; a digital tablet, which includes therein a signal selector, a signal amplifier, an analog-to-digital converter, a microcontroller, and a transmission interface and has a surface on which a scan line grid composed of parallel conductive lines is formed with the scan line grid being inductively coupled to the electromagnetic wave emitting circuit of the digital pen through electromagnetic wave signals and the transmission interface being set in communicating connection with a transmission interface of an external mobile device; and at least one paper sheet, which is positioned on the surface of the digital tablet, and the digital pen which containing an ink cartridge may writes or draws on a paper sheet arranged on a digital tablet to have the writing scripts or drawing data generated by handwriting synchronously transmitted to a mobile device thereby providing an effect of synchronously display the writing scripts or drawing data that a user made on the paper sheet on a screen of the mobile device so as to achieve the purpose of having the writing scripts and drawings data stored in the mobile device or transmitted to a cloud host for storage.

### BACKGROUND OF THE INVENTION

(a) Technical Field of the Invention

The present invention generally relates to a pen input device used with a mobile device, and more particularly to a digital pen containing an ink cartridge that allows for writing or drawing on a paper sheet arranged on a digital tablet to have the writing scripts or drawing data generated by handwriting synchronously transmitted to a mobile device thereby providing an effect of synchronously display the writing scripts or drawing data that a user made on the paper sheet on a screen of the mobile device so as to achieve the purpose of having the writing scripts and drawings data stored in the mobile device or transmitted to a cloud host for storage.

(b) Description of the Prior Art

The rapid development of the information industry makes the utilization rate of smart phones and tablet computers increasingly raised. The releases of iOS system platform of Apple Inc. and Android system platform of Google Inc. further pushes forward the popularity of the use of smart phones and tablet computers to such an extent that almost every person owns one of these devices, this being due to the powerful functionality of these devices being as good as desktop computers and the compact outside appearance and the light weight of these device allowing a user to easily carry, breaking the constraint that a conventional computer must be installed at a fixed site or a bulky and heavy notebook computer must be carried and allowing a user to use and operate apps of a smart phone or a tablet computer at any time and any place for working or website browsing. In addition, a touch control type user interface is used to allow for operation to be achieved with a single finger sliding on a screen, this making it possible for a user to be freed from the constraints of keyboards and mice. Furthermore, the open architecture and profit sharing arrangement makes more people to develop various apps for iOS system platform or Android system platform of smart phones and tablet computers, which, besides the traditional software for word processing and electronic mails and network browsers, more and more innovative software for games, entertainment, drawings, and note-taking are developed and announced, so that the application of the tablet computers is getting increasingly wider, and its usefulness has long been beyond the conventional computers, making them become the general consumer indispensable information equipment.

Today, drawing or taking notes on the tablet computer has occupied a large proportion of the tablet computer applications. Although a touch-to-control style user interface allows writing or drawing to be directly made on a tablet screen with a finger as a pen or stylus, the inherent limitation of the touch-to-control interface make it impossible to make fine and delicate writing or drawing on a tablet screen. Even to use the so-called capacitive stylus, which just simply mimics the action of a finger, still cannot achieve the effect of writing thin character. Further, the sensation of making writing on a tablet screen with a finger or a capacitive stylus is generally of no match at all of that of using an actual pen to write on an actual sheet of paper. Thus, the touch-to-control style input of a tablet computer is inherently constraining and un-improvable for applications of drawing and making notes.

Apparently, although the smart phones and the tablet computers are the novelist technical products, they possess various disadvantages and they are not in consistency with the general habits of general consumers. This makes them an imperfect design and further improvement will be needed.

Thus, the present invention aims to provide a solution for overcoming the technical shortcomings so as to eliminate the above-mentioned drawbacks.

### SUMMARY OF THE INVENTION

An object of the present invention is to provide a pen input device used with a mobile device, which comprises a digital pen containing an ink cartridge that allows for writing or drawing on a paper sheet arranged on a digital tablet to have the writing scripts or drawing data generated by handwriting synchronously transmitted to a mobile device thereby providing an effect of synchronously display the writing scripts or drawing data that a user made on the paper sheet on a screen of the mobile device so as to achieve the purpose of having the writing scripts and drawings data stored in the mobile device or transmitted to a cloud host for storage.

To achieve the above object, the present invention provides a pen input device used with a mobile device, which comprises:

a digital pen containing an ink cartridge, and electromagnetic wave emitting circuit;

a digital tablet containing a signal selector, a signal amplifier, an analog-to-digital converter, a microcontroller, and a transmission interface, and a scan line grid composed of parallel conducting wires being provided on the surface of said digital tablet, the scan line grid being inductively coupled to the electromagnetic wave emitting circuit of the digital pen through electromagnetic wave signals, the transmission interface of the digital tablet being set in communicating connection with a transmission interface of an external mobile device; and

at least one paper sheet, wherein each paper sheet is positioned on the surface of said digital tablet.

The present invention provides a pen input device used with a mobile device, which comprises a digital pen containing an ink cartridge that allows for writing or drawing on a paper sheet arranged on a digital tablet to have the writing scripts or drawing data generated by handwriting synchronously transmitted to a mobile device thereby providing an effect of synchronously display the writing scripts or drawing data that a user made on the paper sheet on a screen of the mobile device so as to achieve the purpose of having the writing scripts and drawings data stored in the mobile device or transmitted to a cloud host for storage.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention in an assembled condition.

FIG. 3 is a block diagram of the present invention.

FIG. 4 is a schematic view illustrating a condition of wireless transmission of the present invention.

FIG. 5 is a schematic view illustrating a condition of wired transmission of the present invention.

FIG. 6 is a block diagram of the present invention in the form of an iOS device.

FIG. 7 is a block diagram of the present invention in the form of an Android device.

FIG. 8 is a schematic view illustrating a condition of transmission of writing scripts or drawings data to a cloud host or a community website according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

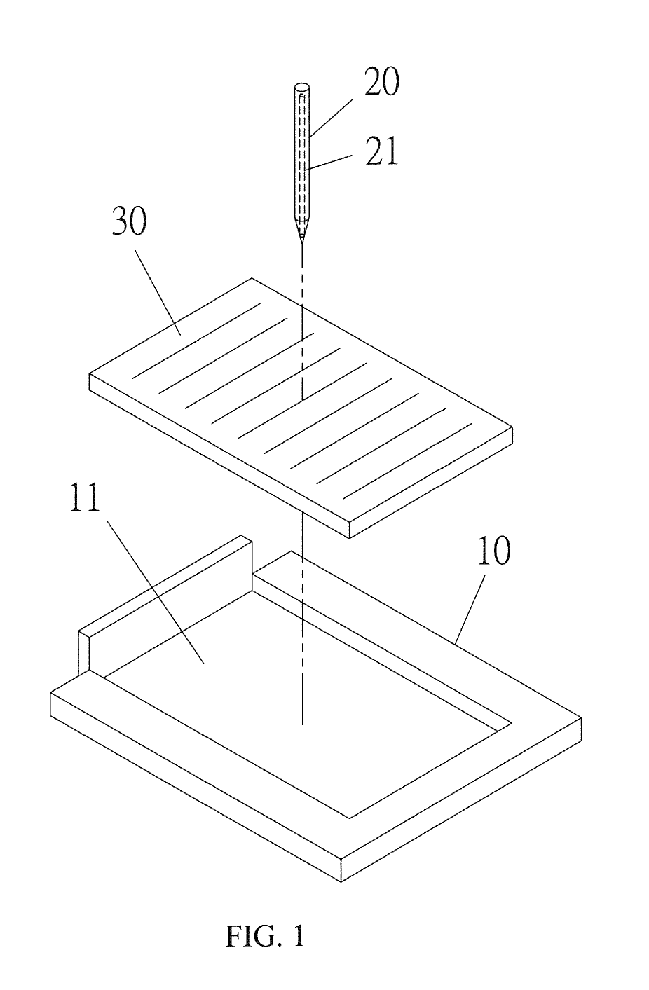

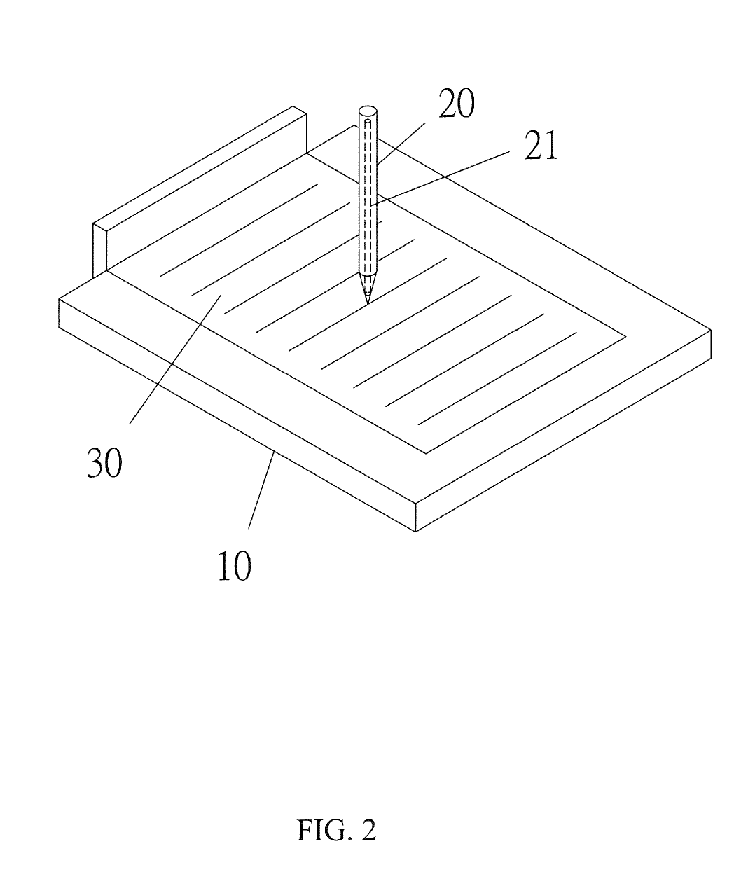

Referring to FIGS. 1 and 2, which are respectively an exploded view and a perspective view of an assembled form of the present invention, the present invention provides a pen input device used with a mobile device, which comprises:

a digital pen 20 containing an ink cartridge 21, a digital tablet 10, and at least one paper sheet 30, each paper sheet 30 can be positioned on a surface 11 of the digital tablet 10 to allow the digital pen 20 that contains the ink cartridge 21 to write and form ink scripts thereon so as to form a paper manuscript.

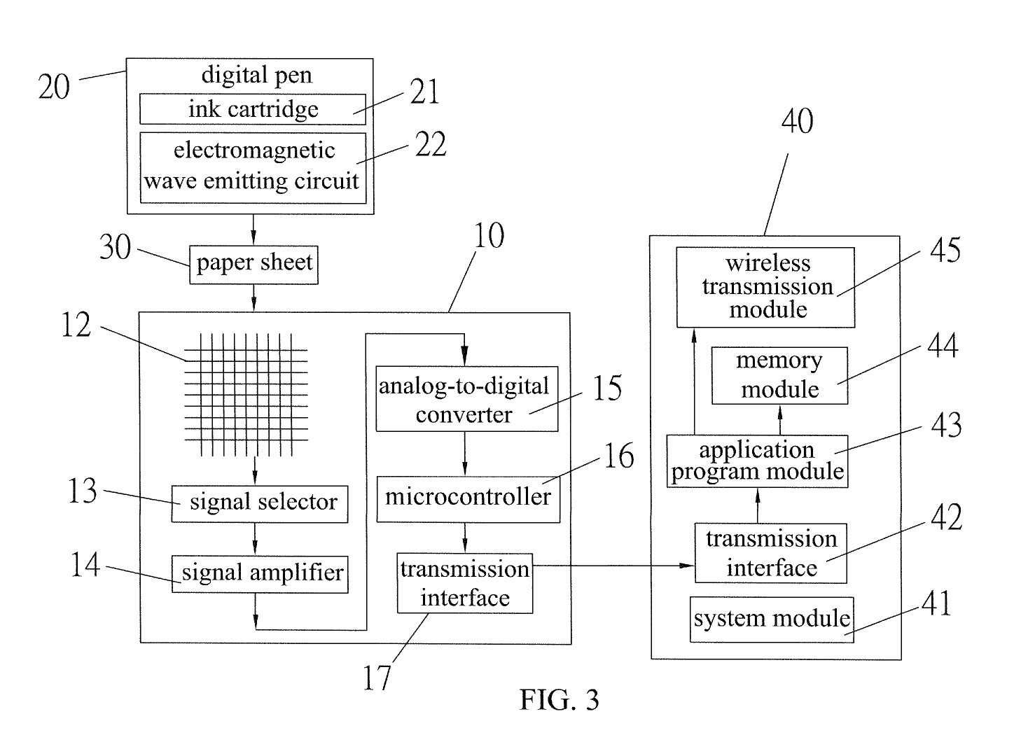

Referring to FIGS. 2, 3, and 6, a first illustrative example of the present invention is illustrated, wherein the present invention provides a pen input device used with a mobile device, which comprises:

a digital pen containing an ink cartridge 21 and electromagnetic wave emitting circuit 22, the electromagnetic wave emitting circuit 22 being an active oscillator circuit or an electromagnetic induction resonant circuit, the later being capable of generating resonance when excited by an external signal and maintaining oscillation for a short period of time after the external signal is removed, whereby electromagnetic waves are emitted during the oscillation of such a short period of time;

a digital tablet 10 containing a signal selector 13, a signal amplifier 14, an analog-to-digital converter 15, a microcontroller 16, and a transmission interface 17, and a scan line grid 12 composed of parallel conducting wires being provided on the surface 11 of said digital tablet 10, the scan line grid 12 being inductively coupled to the electromagnetic wave emitting circuit 22 of the digital pen 20 through electromagnetic wave signals, the transmission interface 17 of the digital tablet 10 being in communicating connection with the transmission interface 42 of the external mobile device 40; and

at least one paper sheet 30, wherein each paper sheet 30 can be positioned on the surface 11 of the digital tablet 10, each paper sheet 30 corresponding in position to the scan line grid 12 of the digital tablet 10 to allow the digital pen 20 that contains the ink cartridge 21 to write and form ink scripts thereon so as to form a paper manuscript.

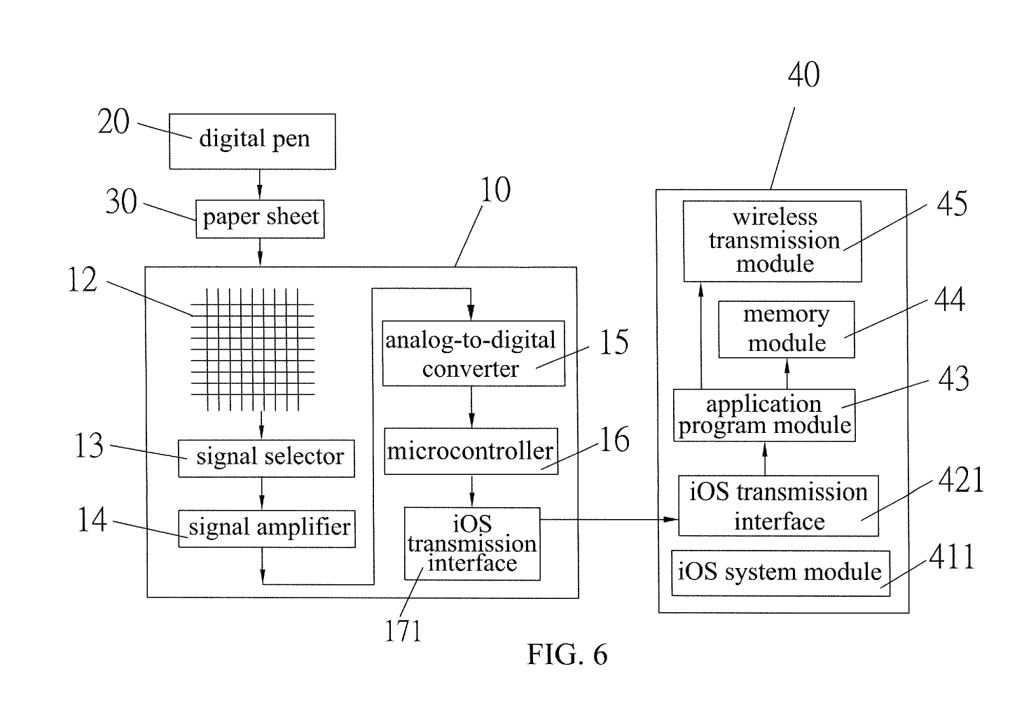

Referring to FIG. 6, the transmission interface 17 of the digital tablet 10 can be for example an iOS transmission interface 171 and the mobile device 40 can be an iOS device, such as iPhone, iPad, and iPod. The mobile device 40 may comprise therein a system module 41 and the system module 41 can be an iOS system module 411. The mobile device 40 may further comprise therein a transmission interface 42 and the transmission interface 42 can be an iOS transmission interface 421. The iOS transmission interface 421 of the mobile device 40 is in communicating connection with the iOS transmission interface 171 of the digital tablet 10. The mobile device 40 may further comprise therein an application program module 43 and the application program module 43 is electrically connected with the iOS transmission interface 421 of the mobile device 40. The application program module 43 can be a handwriting note software, or drawing software, or electronic mail software. The mobile device 40 may further comprise therein a memory module 44 and the memory module 44 is electrically connected with the application program module 43. The mobile device 40 may further comprise therein a wireless transmission module 45 and the wireless transmission module 45 is electrically connected with the application program module 43. The wireless transmission module 45 can be a 3G communication module, a 4G communication module, a WiFi wireless network module, or an iOS wireless transmission module.

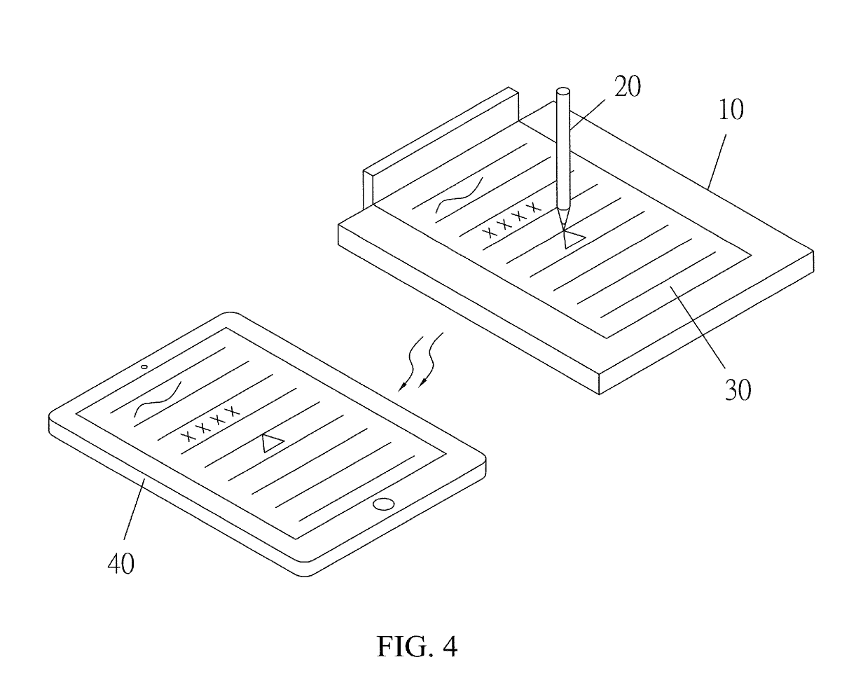

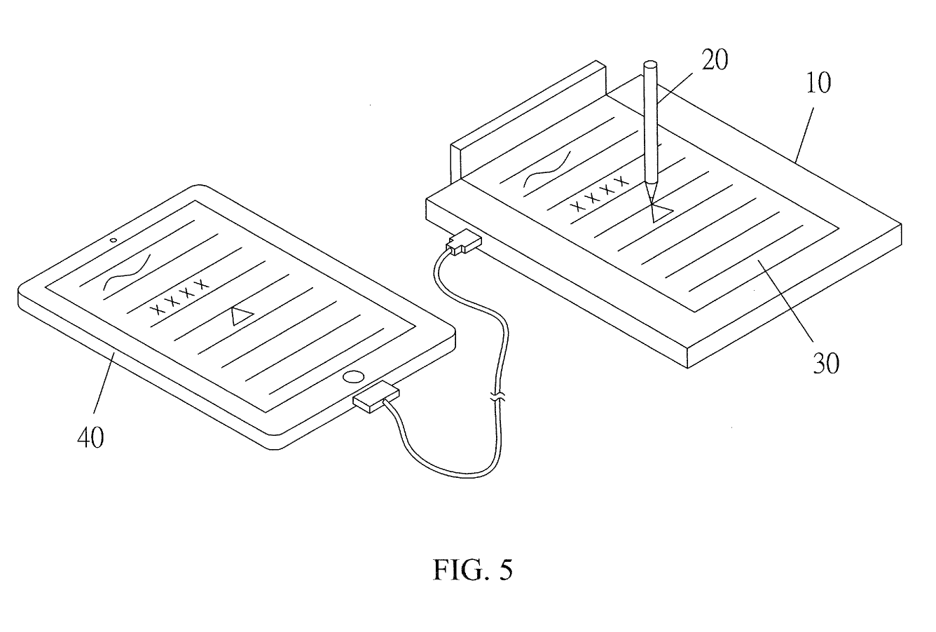

Referring to FIGS. 4, 5, and 6, when a user intends to use the digital pen 20 of the present invention to make writing on the surface 11 of the digital tablet 10, with the digital pen 20 of the present invention containing therein the ink cartridge 21 and the paper sheet 30 positioned on the surface 11 of the digital tablet 10, an affect that the digital pen 20 that contains the ink cartridge 21 is operated to write and form ink scripts on the paper sheet 30. And, when the digital pen 20 that contains the ink cartridge 21 is writing on the paper sheet 30 positioned on the surface 11 of the digital tablet 10, the scan line grid 12 of the surface 11 of the digital tablet 10 synchronously receives electromagnetic wave signals transmitted from the digital pen 20 so that the scan line grid 12 of the surface 11 of the digital tablet 10 that is located below the digital pen 20 detects the electromagnetic wave signals and generates an electrical current signal. The signal selector 13 may select the scan line grid 12 in which an electrical current is induced and transmits the induced electrical current signal to the signal amplifier 14 to be amplified thereby and the amplified signal is then transmitted to the analog-to-digital converter 15 to be converted into a digital signal, and then the digital signal is transmitted to the microcontroller 16 to be processed thereby so as to convert the digital signal into coordinates and related data. Finally, the coordinates and related data are transmitted through the iOS transmission interface 171 of the digital tablet 10 to the iOS transmission interface 421 of the external mobile device 40. The iOS transmission interface 421 of the mobile device 40 can be set in communicating connection with the iOS transmission interface 171 of the digital tablet 10 by following iOS specifications in a manner of wired transmission shown in FIG. 5 or in a manner of wireless transmission shown in FIG. 4. The wired transmission can be serial or USB or iOS wired transmission element. The wireless transmission can be sound wave or Bluetooth or WiFi or iOS wireless transmission element.

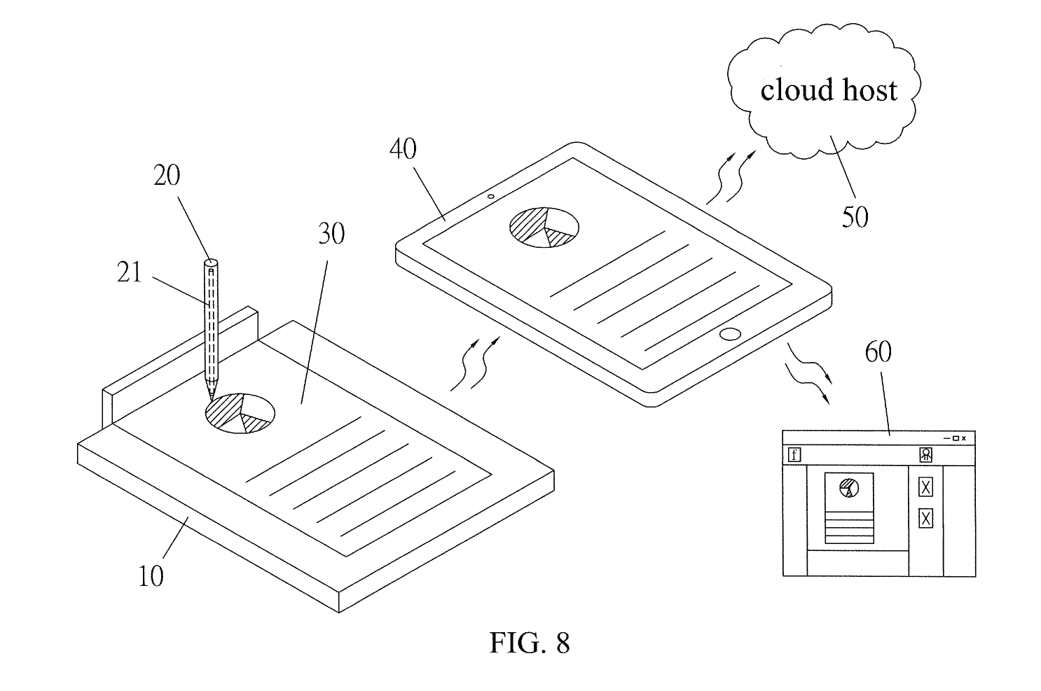

Further, referring to FIG. 6, the data, after being received by the iOS transmission interface 421 of the iOS device, are transmitted to the application program module 43 of the mobile device 40 to be received and processed thereby. The application program module 43 can be a handwriting note software or drawing software or electronic mail software. The data received by the application program module 43 can be that representing the coordinates and related data of the digital pen 20 moving on the paper sheet 30 of the surface 11 of the digital tablet 10. The application program module 43 may apply the coordinates and related data to a function that operates software, such as selecting pen type or selecting line color or paste and cut. The coordinates and related data can also be processed by the application program module 43 to have the coordinates and related data collected to form data of a trace and such trace data can be displayed on a screen of the mobile device 40 to form a graph or handwriting scripts or to be converted by handwriting recognition software into computer character form of computer text so that the handwriting scripts or the computer forms can achieve a function of being used to make notes with note preparation software or being used to make drawings with drawing software thereby form an electronic document or an electronic mail containing both text and drawings. With the arrangement that the mobile device comprises therein the memory module 44, a user is allowed, if desired, to store data in the memory module 44 so that the writing scripts or drawings that the user makes on the paper sheet 30 can be synchronously displayed on a screen of the mobile device 40 thereby achieving a function that the user may operate functions of software, edit, transmit, or store. Further, as shown FIG. 8, the wireless transmission module 45 may transmit the data in electronic mails or transmit electronic documents to a cloud host 50 for storage therein to allow the writing scripts and the drawing data that the user make to be stored at a location beyond the manuscript of the paper sheet 30 and also to allow the user to transmit the writing scripts and the drawings data to the cloud host 50 for storage, if desired, and also to transmit the data through the wireless transmission module 45 to a community website 60 to share with other persons.

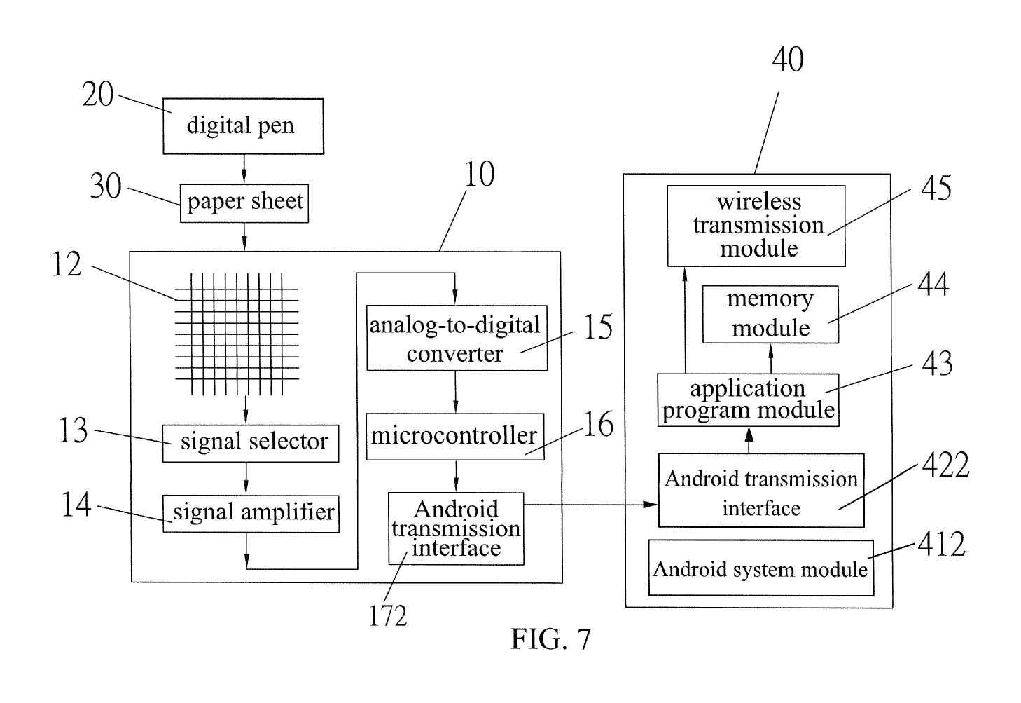

Referring to FIGS. 2 and 7, a second illustrative example of the present invention is illustrated, wherein the present invention provides a pen input device used with a mobile device, which comprises:

a digital pen 20 containing an ink cartridge 21 and the digital pen 20 comprises therein an electromagnetic wave emitting circuit 22, the electromagnetic wave emitting circuit 22 being an active oscillator circuit or an electromagnetic induction resonant circuit, the later being capable of generating resonance when excited by an external signal and maintaining oscillation for a short period of time after the external signal is removed, whereby electromagnetic waves are emitted during the oscillation of such a short period of time;

a digital tablet 10 containing a signal selector 13, a signal amplifier 14, an analog-to-digital converter 15, a microcontroller 16, and a transmission interface 17, the transmission interface 17 being an Android transmission interface 172, and a scan line grid 12 composed of parallel conducting wires being provided on the surface 11 of said digital tablet 10, the scan line grid 12 being inductively coupled to the electromagnetic wave emitting circuit 22 of the digital pen 20 through electromagnetic wave signals; and

at least one paper sheet 30, wherein each paper sheet 30 can be positioned on the surface 11 of the Digital tablet 10, each paper sheet 30 corresponding in position to the scan line grid 12 of the digital tablet 10 to allow the digital pen 20 that contains the ink cartridge 21 to write and form ink scripts thereon so as to form a paper manuscript.

Referring to FIG. 7, the Android transmission interface 172 of the digital tablet 10 can be set in communicating connection with an external mobile device 40. The mobile device 40 can be an Android device. The mobile device 40 may comprise therein a system module 41 and the system module 41 can be an Android system module 412. The mobile device 40 may further comprise therein a transmission interface 42 and the transmission interface 42 can be an Android transmission interface 422. The Android transmission interface 422 of the mobile device 40 is in communicating connection with the Android transmission interface 172 of the digital tablet 10. The mobile device 40 may further comprise therein an application program module 43 and the application program module 43 is electrically connected with the transmission interface 42 of the mobile device 40. The application program module 43 can be a handwriting note software, or drawing software, or electronic mail software. The mobile device 40 may further comprise therein a memory module 44 and the memory module 44 is electrically connected with the application program module 43. The mobile device 40 may further comprise therein a wireless transmission module 45 and the wireless transmission module 45 is electrically connected with the application program module 43. The wireless transmission module 45 can be a 3G communication module, a 4G communication module, a WiFi wireless network module, or an Android wireless transmission module.

Referring to FIGS. 4, 5, and 7, when a user intends to use the digital pen 20 of the present invention to make writing on the surface 11 of the digital tablet 10, with the digital pen 20 of the present invention containing therein the ink cartridge 21 and the paper sheet 30 positioned on the surface 11 of the digital tablet 10, an affect that the digital pen 20 that contains the ink cartridge 21 is operated to write and form ink scripts on the paper sheet 30. And, when the digital pen 20 that contains the ink cartridge 21 is making writing on the paper sheet 30 positioned on the surface 11 of the digital tablet 10, the scan line grid 12 of the surface 11 of the digital tablet 10 synchronously receives electromagnetic wave signals transmitted from the digital pen 20 so that the scan line grid 12 of the surface 11 of the digital tablet 10 that is located below the digital pen 20 detects the electromagnetic wave signals and generates an electrical current signal. The signal selector 13 may select the scan line grid 12 in which an electrical current is induced and transmits the induced electrical current signal to the signal amplifier 14 to be amplified thereby and the amplified signal is then transmitted to the analog-to-digital converter 15 to be converted into a digital signal, and then the digital signal is transmitted to the microcontroller 16 to be processed thereby so as to convert the digital signal into coordinates and related data. Finally, the coordinates and related data are transmitted through the Android transmission interface 172 of the digital tablet 10 to the Android transmission interface 422 of the external mobile device 40. The Android transmission interface 422 of the mobile device 40 can be set in communicating connection with the Android transmission interface 172 of the digital tablet 10 by following Android specifications in a manner of wired transmission shown in FIG. 5 or in a manner of wireless transmission shown in FIG. 4. The wired transmission can be serial or USB or Android wired transmission element. The wireless transmission can be sound wave or Bluetooth or WiFi or Android wireless transmission element.

Further, referring to FIG. 7, the data, after being received by the Android transmission interface 422 of the Android device, are transmitted to the application program module 43 of the mobile device 40 to be received and processed thereby. The application program module 43 can be a handwriting note software or drawing software or electronic mail software. The data received by the application program module 43 can be that representing the coordinates and related data of the digital pen 20 moving on the paper sheet 30 of the surface 11 of the digital tablet 10. The application program module 43 may apply the coordinates and related data to a function that operates software, such as selecting pen type or selecting line color or paste and cut. The coordinates and related data can also be processed by the application program module 43 to have the coordinates and related data collected to form data of a trace and such trace data can be displayed on a screen of the mobile device 40 to form a graph or handwriting scripts or to be converted by handwriting recognition software into computer character form of computer text so that the handwriting scripts or the computer forms can achieve a function of being used to make notes with note preparation software or being used to make drawings with drawing software thereby form an electronic document or an electronic mail containing both text and drawings. With the arrangement that the mobile device comprises therein the memory module 44, a user is allowed, if desired, to store data in the memory module 44 so that the writing scripts or drawings that the user makes on the paper sheet 30 can be synchronously displayed on a screen of the mobile device 40 thereby achieving a function that the user may operate functions of software, edit, transmit, or store. Further, as shown FIG. 8, the wireless transmission module 45 may transmit the data in electronic mails or transmit electronic documents to a cloud host 50 for storage therein to allow the writing scripts and the drawing data that the user make to be stored at a location beyond the manuscript of the paper sheet 30 and also to allow the user to transmit the writing scripts and the drawings data to the cloud host 50 for storage, if desired, and also to transmit the data through the wireless transmission module 45 to a community website 60 to share with other persons.

In summary, the present invention provides a combination of a mobile device 40 and a digital tablet 10, where the mobile device 40 can be an iOS device or an Android device, and the said digital tablet 10 is provided with at least one paper sheet 30, whereby with the arrangement that the digital pen comprises therein an ink cartridge, the digital pen that contains the ink cartridge can be used to directly make writing or drawings on the paper sheet 30 so as to enter writing scripts or drawing data into the mobile device 40 in a manner of being closer to the natural writing habit and sensation of human beings thereby overcoming the drawback of a conventional mobile device 40 that using a user's finger to make writing or drawing on a glass screen is not in compliance with the natural writing habit of human beings. Further, the digital tablet 10 of the present invention has a resolution that is far higher than the resolution of the touch-to-control interface of the mobile device 40 and the contact area of the ink cartridge 21 of the digital pen 20 is far smaller than the contact area of a finger so that the user is allowed to input finer writing scripts and more precise lines so as to overcome the drawback of the conventional mobile device 40 that using a finger to make writing on a touch-to-control interface cannot make the writing scripts thinner and precisely handling the drawing lines.

The pen input device used with a mobile device according to the present invention, when compared with known techniques, shows the following advantages:

(1) The present invention provides a combination of a mobile device and a digital tablet and the mobile device can be an iOS device or an Android, and set a paper sheet on said digital tablet so that through the use of a digital pen that contains an ink cartridge to directly write or draw on the paper sheet, writing scripts or drawing data can be entered into the mobile device in a manner of being closer to the natural writing habit and sensation of human beings thereby overcoming the drawback of the conventional mobile device that using a user's finger to make writing or drawing on a glass screen is not in compliance with the natural writing habit of human beings.

(2) The present invention makes use of the facts that the resolution of the digital tablet is far higher than the resolution of a touch-to-control interface of the mobile device and the contact area of an ink cartridge is far smaller than the contact area of a finger to allow a user to input finer writing scripts and more precise lines so as to overcome the drawback of the conventional mobile device that using a finger to make writing on a touch-to-control interface cannot make the writing scripts thinner and precisely handling the drawing lines.

(3) The writing scripts and drawings that a user makes on the paper sheet can be reproduced, exactly as the originals, on a screen of a mobile device to allow for edit, transmission, and store by a user.

(4) In addition to transmission of the writing scripts and drawings that a user makes on the paper sheet to a mobile device, the writing scripts and drawings made by the user can be preserved as a paper manuscript.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pen input device used with mobile device comprising:
a digital pen containing an ink cartridge, and electromagnetic wave emitting circuit;
a digital tablet containing a signal selector, a signal amplifier, an analog-to-digital converter, a microcontroller, and a transmission interface which is an iOS transmission interface, and a scan line grid composed of parallel conducting wires being provided on the surface of said digital tablet, the scan line grid being inductively coupled to the electromagnetic wave emitting circuit of the digital pen through electromagnetic wave signals; and
at least one paper sheet, wherein each paper sheet is positioned on the surface of said digital tablet.

2. The pen input device used with mobile device of claim 1, wherein the electromagnetic wave emitting circuit of the digital pen comprises an active oscillator circuit.

3. The pen input device used with mobile device of claim 1, wherein the electromagnetic wave emitting circuit of the digital pen comprises an electromagnetic induction resonant circuit.

4. The pen input device used with mobile device of claim 1, wherein the iOS transmission interface of the digital tablet comprises wired transmission.

5. The pen input device used with mobile device of claim 1, wherein the iOS transmission interface of the digital tablet comprises wireless transmission.

6. A pen input device used with mobile device comprising:
a digital pen containing an ink cartridge and an electromagnetic wave emitting circuit;
a digital tablet containing a signal selector, a signal amplifier, an analog-to-digital converter, a microcontroller, and a transmission interface which is an Android transmission interface, and a scan line grid composed of parallel conducting wires being provided on the surface of said digital tablet, the scan line grid being inductively coupled to the electromagnetic wave emitting circuit of the digital pen through electromagnetic wave signals; and
at least one paper sheet, wherein each paper sheet is positioned on the surface of said digital tablet.

7. The pen input device used with mobile device of claim 6, wherein the electromagnetic wave emitting circuit of the digital pen comprises an active oscillator circuit.

8. The pen input device used with mobile device of claim 6, wherein the electromagnetic wave emitting circuit of the digital pen comprises an electromagnetic induction resonant circuit.

9. The pen input device used with mobile device of claim 6, wherein the Android transmission interface of the digital tablet comprises wired transmission.

10. The pen input device used with mobile device of claim 6, wherein the Android transmission interface of the digital tablet comprises wireless transmission.
